(19) United States
(12) Patent Application Publication
(10) Pub. No.: US 2013/0139438 A1
(43) Pub. Date: Jun. 6, 2013

(54) COLLAPSIBLE HANGING BASKET

(71) Applicant: Raymon W. LUSH, Bloomfield, NE (US)

(72) Inventor: Raymon W. LUSH, Bloomfield, NE (US)

(73) Assignee: Woodstream Corporation

(21) Appl. No.: 13/596,493

(22) Filed: Aug. 28, 2012

Related U.S. Application Data
(63) Continuation of application No. 12/657,363, filed on Jan. 19, 2010, now abandoned.

(51) Int. Cl. A01G 9/02

(52) U.S. Cl. CPC A01G 9/024
USPC 47/65.7; 47/67

(57) ABSTRACT

A hanging basket for plants, flowers, etc. is provided which may be moved from a collapsed position to an extended position. When in the extended position, the hanging basket may support plants, flowers or the like therein. When collapsed, the basket occupies very little space for shipping and storage purposes.

This is a continuation application of application Ser. No. 12/12,657,363 filed on Jan. 19, 2010, the priority of which is hereby claimed.

### BACKGROUND OF THE INVENTION

1. Field of the Invention

This invention relates to a hanging basket and more particularly to a collapsible hanging basket for plants, flowers, etc. Even more particularly, this invention relates to a hanging basket which may be moved between collapsed and extended positions.

2. Description of the Related Art

Many types of hanging baskets have been previously provided for supporting or containing plants, flowers, etc. Prior art hanging baskets that are not collapsible are difficult to ship, display and store. Further, hanging baskets of the prior art often do not provide for sufficient aeration and drainage of the potting soil or the like contained within the basket.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one embodiment of the invention, the hanging basket has upper and lower ends and is capable of being moved between collapsed and extended positions. The hanging basket comprises a horizontally disposed upper support ring. The hanging basket also comprises a series of truncated V-shaped connectors having a pair of legs with upper and lower ends and a straight portion extending between the lower ends of the legs. The upper ends of the legs of the truncated V-shaped connectors are pivotally secured to the upper support ring. Each leg of each truncated V-shaped connector is crossed by a leg of the adjacent connector to provide openings therebetween. The hanging basket also includes a horizontally disposed lower support ring which is spaced below the upper support ring. The hanging basket further includes a series of truncated inverted V-shaped connectors having a pair of legs with upper and lower ends and a straight portion extending between the upper ends of the legs. The straight portions of the truncated V-shaped connectors are pivotally secured to the straight portions of the truncated inverted V-shaped connectors by collars or sleeves whereby the basket may be selectively moved between an extended position and a collapsed position.

A bottom wall is secured to the lower support ring and extends thereacross which at least partially closes the lower end of the basket to prevent the contents thereof from passing downwardly therethrough. A hanger is secured to the upper support ring for selectively supporting the hanging basket in its extended position.

In another embodiment of the invention, the hanging basket includes an upper support ring with a hanger secured thereto and which extends upwardly therefrom. A collapsible mesh wall, having upper and lower ends, is secured at its upper end to the upper support ring and extends downwardly therefrom. Structure is secured to the lower end of the mesh wall for at least partially closing the lower end thereof. In this embodiment, the mesh wall is preferably comprised of a metal material. The mesh wall may have different configurations such as inverted truncated cone, truncated cone, hourglass or lantern.

In both of the embodiments, the hanging baskets may be used in their extended positions so that plants, flowers, or the like may be contained therein. In each of the embodiments, when the hanging basket is being shipped or stored, the baskets may be moved to their collapsed positions so as to occupy a much smaller space than when in their extended positions.

Therefore, it is an object of the present invention to provide an improved hanging basket.

A further object of the present invention is to provide a collapsible hanging basket.

A further object of the present invention is to provide a hanging basket for plants, flowers, etc. which may be selectively moved between an extended position and a collapsed position for storage, display or shipping.

A further object of the present invention is to provide a hanging basket which provides proper aeration and drainage of the plants or flowers contained therein. These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of one embodiment of the hanging basket of the present invention in its extended position.

FIG. 2 is a side view of the hanging basket shown in FIG. 1 in its extended position.

FIG. 3 is a side view of the hanging basket shown in FIG. 2 in its partially collapsed position.

FIG. 4 is a perspective view illustrating the hanging basket shown in FIGS. 1-3 in its collapsed position.

FIG. 5 is a perspective view of a further embodiment of the invention.

FIG. 6 is a side view of the hanging basket shown in FIG. 5.

FIG. 7 is a side view of the hanging basket shown in FIG. 6 in its collapsed position.

FIG. 8 is a partial perspective view of a portion of the hanging basket shown in FIG. 1.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

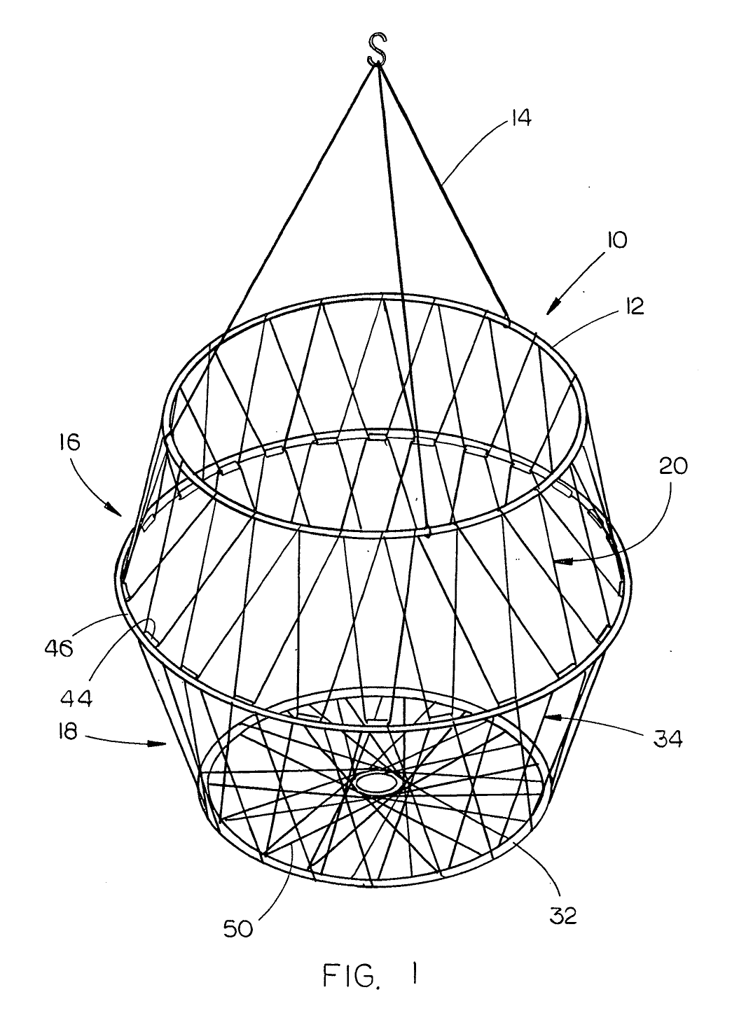

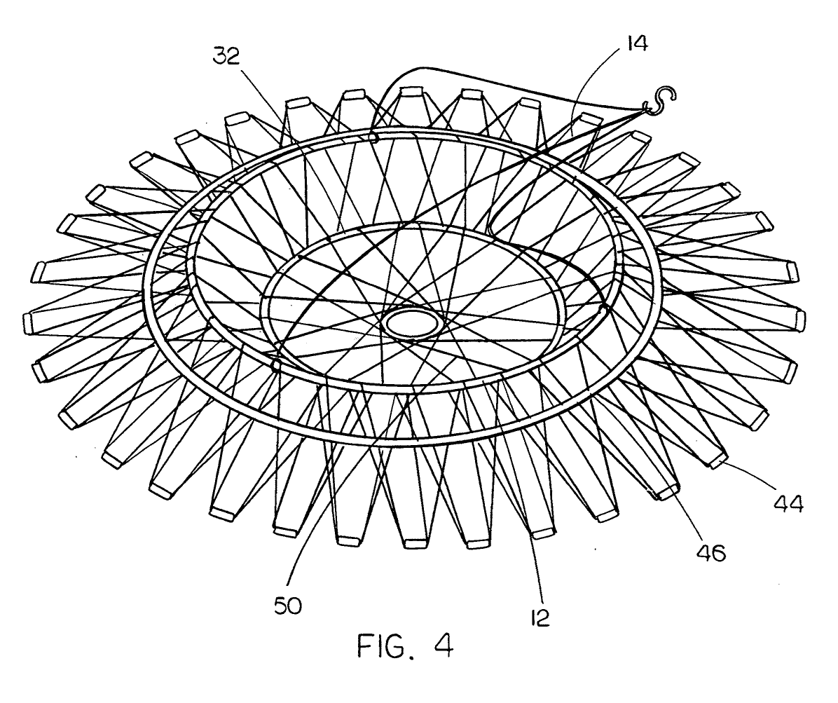

In FIGS. 1-4 and 8, the numeral 10 refers to one embodiment of the hanging basket of this invention. Basket 10 includes an upper support ring 12 having a hanger assembly 14 secured thereto and extending therefrom so that the basket 10 may be supported from a conventional support such as a shepherd's hook or the like. Basket 10 will be described as including an upper basket portion 16, which includes the support ring 12, and a lower basket portion 18.

The numerals 20 refer to a series of truncated V-shaped connectors including legs 22 and 24 and a straight portion 26 extending between the lower ends of legs 22 and 24. The upper ends of legs 22 and 24 have generally U-shaped eyes 28 and 30 formed therein respectively which are pivotally secured to ring 12. The connectors 20 are spaced apart a distance equal to one-half of the distance between the eyes 28 and 30. As seen, each leg of each connector 20 is crossed by a leg of the adjacent connector 20 to provide openings therebetween which are sized so as to contain the potting soil or the like contained within the basket but large enough to provide aeration and drainage for the potting soil or the like contained within the basket 10.

Lower basket portion 18 includes a support ring 32 having a series of truncated, inverted V-shaped connectors 34 secured thereto which extend upwardly therefrom. Each of the connectors 34 includes legs 36 and 38 and a straight portion 39 extending between the upper ends of the legs 36 and 38. The lower ends of legs 36 and have generally U-shaped eyes 40 and 42 formed therein respectively which are pivotally secured to ring 32.

The connectors 34 are spaced-apart at a distance equal to one-half of the distance between the eyes 40 and 42. As seen, each leg of each connector 34 is crossed by a leg of the adjacent connector to provide openings therebetween which are of a size to contain the potting soil or the like therein but which have an opening sufficient to provide proper aeration and drainage for the potting soil.

A collar or sleeve 44 pivotally embraces the straight portions 26 and 39 of the connectors 20 and 34. Preferably, but not necessarily, a retaining ring 46 extends around the upper and lower basket portions 16 and 18 at the juncture of the basket portions 16 and 18 with the retaining ring 46 being detachably secured to the collars 44 by clips 48 to maintain the basket 10 in its extended position by preventing pivotal movement of the basket portions 16 and 18 with respect to each other.

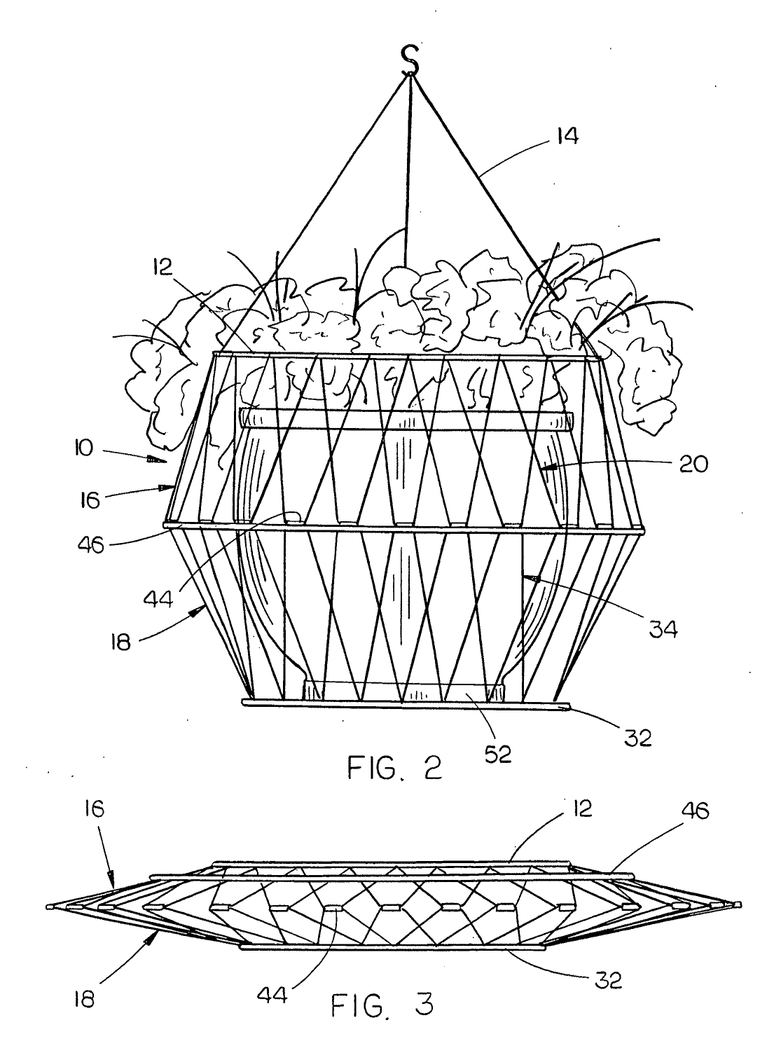

The lower end of the hanging basket 10 is closed by any suitable means such as by crossing wires 50 secured to and extending across the ring 32. The crossing wires 50 could be replaced by a plate or a perforated plate if so desired. Normally, the hanging basket 10 will have potting soil or th˜like contained therein but it could have a removable plant or flower container 52 positioned therein as seen in FIG. 2.

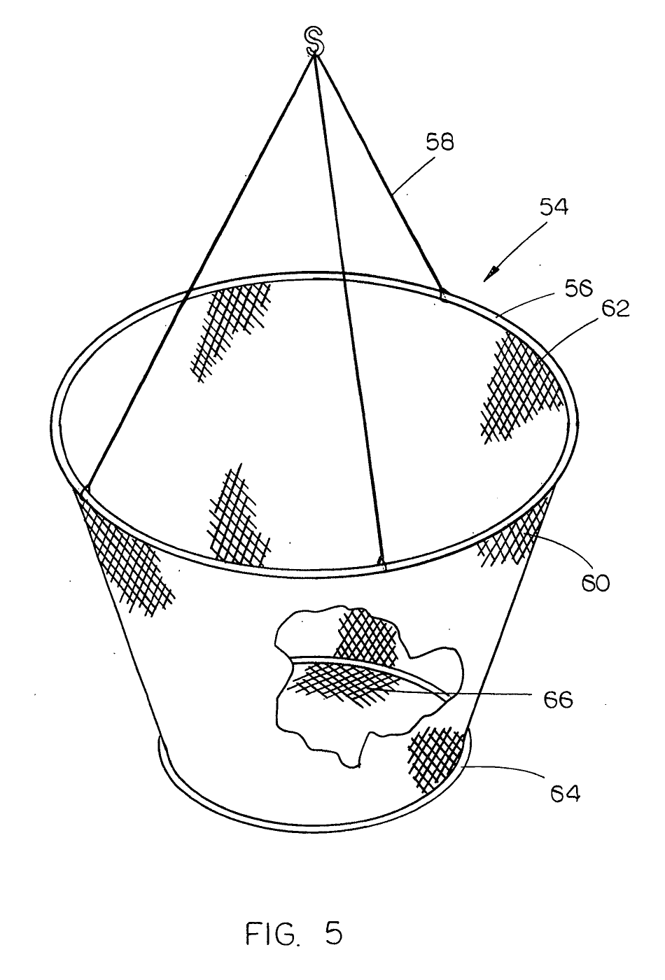

FIGS. 5-7 illustrate a modified form of the invention which is referred to generally by the reference numeral 54. Basket 54 includes an upper support ring 56 having a hanger assembly 58 secured thereto which extends therefrom for connection to a suitable support. A collapsible metal mesh wall 60 has its upper end secured to the support ring 56 by any convenient and extends downwardly therefrom as illustrated in FIG. 5. The mesh wall 60 defines openings 62 therein. The mesh wall 60 is of the type described in U.S. Pat. Nos. 6,047,661; 6,073,582; and 7,185,605. The lower end of mesh wall 60 has a support ring 64 secured thereto. Preferably, a mesh bottom 66 is also secured to ring 64 and extends therebetween. Although it is preferred that a mesh bottom 66 be utilized, a perforated plate could also be used if so desired.

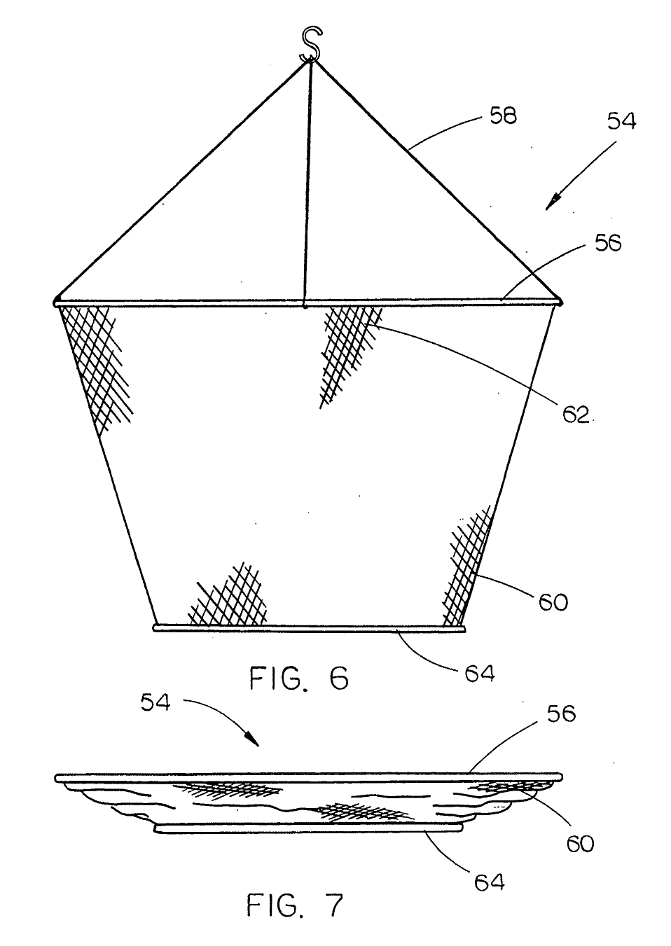

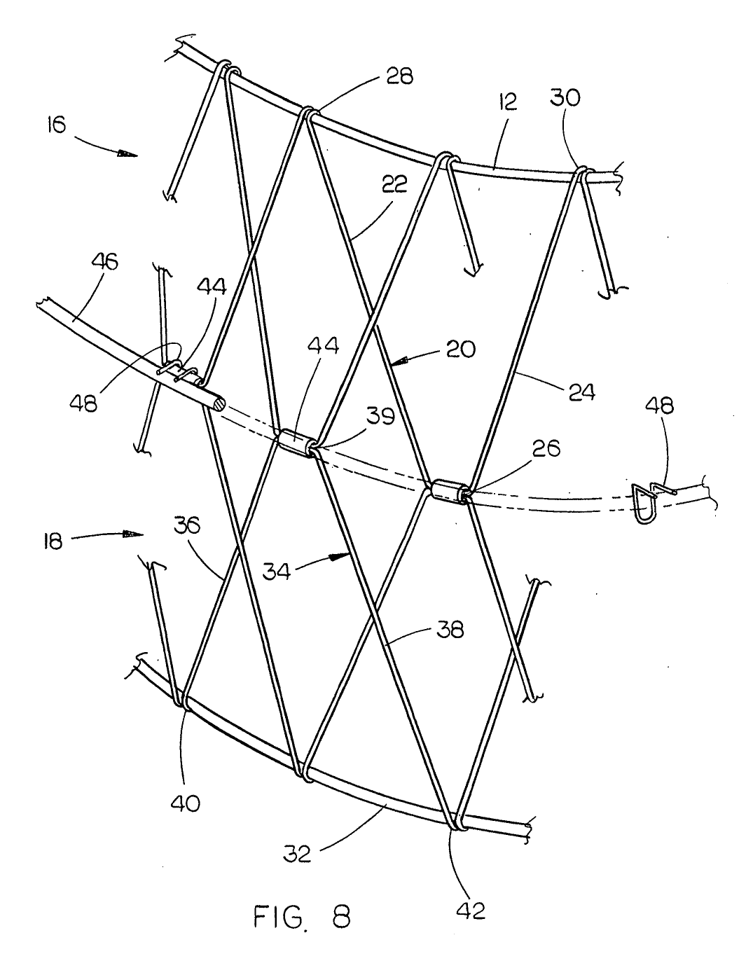

FIG. 6 illustrates the hanging basket 54 in its fully extended position while FIG. 7 illustrates the hanging basket 54 in its collapsed position which is made possible by the collapsible mesh wall 60.

Thus it can be seen that a novel hanging basket has been provided which may be fully extended for use so as to contain plants, flowers, etc. therein but which may also be collapsed so as to occupy very little space for shipping or storage purposes. Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A hanging basket, having upper and lower ends, capable of being moved between collapsed and extended positions, comprising:
a horizontally disposed upper support ring;
a series of truncated V-shaped connectors having a pair of legs with upper and lower ends and a straight portion extending between the lower ends of said legs;
said upper ends of said legs being pivotally secured to said upper support ring;
each leg of each truncated V-shaped connector being crossed by a leg of the adjacent connector to provide openings therebetween;
a horizontally disposed lower support ring spaced below said upper support ring and generally parallel thereto;
a series of truncated, inverted V-shaped connectors having a pair of legs with upper and lower ends and a straight portion extending between the upper ends of said legs;
each of said straight portions of said truncated V-shaped connectors being pivotally secured to an abutting one of said straight portions of said truncated inverted V-shaped connectors within a respective one of a plurality of generally horizontally oriented tubular sleeves through which the straight portions extend, pivoting movement between the straight portions within the sleeves enabling the basket to be moved between an extended position and a collapsed position;
a generally horizontally oriented detachable retaining ring extending around a perimeter of said basket adjacent an outer surface of said plurality of sleeves;
and a hanger secured to said upper support ring for selectively supporting the basket in its extended position.

2. The hanging basket of claim 1 further comprising a bottom wall secured to said lower support ring which at least partially closes the lower end of the basket to prevent the contents thereof from passing downwardly therethrough, said bottom wall including a plurality of spaced-apart wires secured to said lower support ring.

3. The hanging basket of claim 1 wherein said retaining ring is substantially parallel with said upper support ring and said lower support ring.

4. The hanging basket of claim 1 wherein said retaining ring surrounds said basket and is substantially on a same horizontal plane with said sleeves.

5. The hanging basket of claim 4 wherein said retaining ring is selectively secured to at least some of said sleeves to maintain the basket in its extended position.

6. The hanging basket of claim 1 wherein the basket is comprised of metal.

7-12. (canceled)

13. The hanging basket of claim 1 further comprising a plurality of fastening elements, at least some of said sleeves being detachably secured to said retaining ring by said fastening elements.

14. A hanging basket, having upper and lower ends, capable of being moved between collapsed and extended positions, comprising:
a horizontally disposed upper support member;
a series of truncated V-shaped connectors having a pair of legs with upper and lower ends and a mid-portion extending between the lower ends of said legs;
said upper ends of said legs being pivotally secured to said upper support member;
each leg of each truncated V-shaped connector being crossed by a leg of the adjacent connector to provide openings therebetween;
a horizontally disposed lower support member spaced below said upper support member;
a series of truncated, inverted V-shaped connectors having a pair of legs with upper and lower ends and a mid-portion extending between the upper ends of said legs;
each of said mid-portions of said truncated V-shaped connectors being pivotally secured to an abutting one of said mid-portions of said truncated inverted V-shaped connectors within a respective one of a plurality of generally horizontally oriented tubular sleeves through which the mid-portions extend, pivoting movement between the mid-portions within the sleeves enabling the basket to be moved between an extended position and a collapsed position;
a generally horizontally oriented detachable retaining member extending around said basket in abutment with an outside surface of said plurality of sleeves, said retaining member maintaining the basket in its extended position by preventing pivotal movement of the mid-portions within the sleeves when the retaining member is in place.

15. The hanging basket of claim 14 wherein said upper support member, said lower support member and said retaining member are generally circular rings, said upper support ring, said lower support ring and said retaining ring being generally parallel with one another when said basket is in said extended position, said basket further comprising a hanger secured to said upper support member for selectively supporting the basket in its extended position.

16. The hanging basket of claim 15 wherein said sleeves are in horizontal alignment with said retaining ring, a basket perimeter defined by said plurality of sleeves extending substantially parallel with and inside an outer basket perimeter defined by said retaining ring.

17. The hanging basket of claim 16 further comprising a plurality of fastening elements, at least some of said sleeves being detachably secured to said retaining ring by said fastening elements.

18. The hanging basket of claim 14 further comprising a plurality of fastening elements, at least some of said sleeves being detachably secured to said retaining ring by said fastening elements.

19. The hanging basket of claim 14 wherein said retaining member surrounds said basket and is on substantially a same horizontal plane with said sleeves.

20. The hanging basket of claim 14 wherein said sleeves are in horizontal alignment with said retaining ring, a basket perimeter defined by said plurality of sleeves extending substantially parallel with and inside an outer basket perimeter defined by said retaining ring.

21. The hanging basket of claim 20 further comprising a plurality of fastening elements, at least some of said sleeves being detachably secured to said retaining ring by said fastening elements.

22. A hanging basket, having upper and lower ends, capable of being moved between collapsed and extended positions, comprising:
a horizontally disposed upper support member;
a series of substantially V-shaped connectors having a pair of legs with upper and lower ends, the legs of each connector being joined to one another at a lower end of said connector, upper ends of said legs of each connector being spaced from one another;
said upper ends of said legs being pivotally secured to said upper support member;
each leg of each substantially V-shaped connector being crossed by a leg of the adjacent connector to provide openings therebetween;
a horizontally disposed lower support member spaced below said upper support member;
a series of inverted generally V-shaped connectors having a pair of legs with upper and lower ends, the legs of each inverted connector being joined to one another at an upper end of said connector, lower ends of said legs of each inverted connector being spaced from one another;
the lower end of each of said V-shaped connectors being pivotally secured to an abutting upper end of one of said inverted connectors by a respective one of a plurality of sleeves, pivoting movement between abutting parts of the connectors as held adjacent one another within the sleeves enabling the basket to be moved between an extended position and a collapsed position;
a generally horizontally oriented detachable retaining member extending around said basket adjacent an outer side of said plurality of sleeves, said retaining member defining a continuous member that surrounds and is immediately adjacent the sleeves in a same horizontal plane therewith.

23. The hanging basket of claim 22 wherein said upper support member, said lower support member and said retaining member are each a generally circular ring, said basket further comprising a hanger secured to said upper support ring for selectively supporting the basket in its extended position.

24. The hanging basket of claim 23 wherein a basket perimeter defined by said plurality of sleeves extends substantially parallel with and inside an outer basket perimeter defined by said retaining ring, at least some of said sleeves being detachably secured to said retaining ring by a plurality of fastening elements, the retaining ring when fastened to the sleeves preventing pivotal movement between the abutting parts of the connectors within the sleeves to keep the basket in its extended position.

25. The hanging basket of claim 24, wherein said plurality of fastening elements includes clips.

26. The hanging basket of claim 23, wherein said retaining member forms a continuous ring encircling and immediately adjacent an outer side of the sleeves, said retaining ring being on substantially a same horizontal plane with said sleeves, at least some of said sleeves being detachably secured to said retaining ring by a plurality of fastening elements.
